(19) United States
(12) Patent Application Publication
(10) Pub. No.: US 2006/0206531 A1
(43) Pub. Date: Sep. 14, 2006

(54) Document managing apparatus

(75) Inventors: Noriyuki Komamura, Mishima-shi (JP); Nobuhiro Shimogori, Kawasaki-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-shi (JP); Toshiba Tec Kabushiki Kaisha, Shinagawa-ku (JP)

(21) Appl. No.: 11/078,061

(22) Filed: Mar. 10, 2005

(51) Int. Cl. G06F 17/30

(52) U.S. Cl. 707/200

(57) ABSTRACT

A document-managing-apparatus includes a file-managing-unit which manages file-managing-information, a file-of-data being entered in the file-managing-information, the data constituting a document which is a managing-target, a document-managing-unit which manages a document-managing-information by arranging the document-managing-information in the particular order, the document-managing-information including classification-information on at least classification attached to the document in the documents managed, an extracting-unit which extracts text-data included in the document, an analyzing-unit which analyzes whether a previously set-text-data-string is included in the text-data extracted or not, the previously set-text-data-string including the classification-information attached to the document, a determining-unit which determines whether the classification-information is included or not based on the analysis-result, an obtaining-unit which obtains the classification-information when the determining-unit determines that the classification-information is included, and an entering-unit which enters the classification-information while related to the document, the classification-information being obtained by the obtaining-unit, when the document obtaining the classification-information is entered in the-document-managing-unit.

### BACKGROUND OF THE INVENTION

1. Field of the Invention

The present invention relates to a document managing apparatus and a document managing program which manage a file of data constituting a document.

2. Description of the Related Art

Jpn. Pat. Appln. KOKAI Publication No. H5-54081 discloses an apparatus in which electronic filing is performed to a document and filed document data is stored. In the apparatus, document search is performed as follows: during the search, the pieces of document data are rearranged in the order in which the file data having the latest final search date is put on the leading end, and a user performs the search while the documents are displayed in the rearranged order. When the user stops the search at the stage in which the necessary document is displayed. Thus, the user can search the target document by stopping the search at the time when the target document is displayed.

Usually the documents are entered while classified. In order to attach the classification to the document, usually it is necessary that the user previously enters the classification in the apparatus. Then, the user gives the previously entered classification to the document when the user enters the document.

In this case, when the user enters the documents by attaching a new classification to the document, the user stores the documents once without attaching the classification, the user produces the new classification, and then the user is required to attach the produced classification to the document. Therefore, the document entering operation becomes complicated in the conventional technology. Further, when the user enters the document while attaching any one of the already-existing classifications to the document in order to avoid such a complicated operation, the classification which is different from the user's desire is attached to the document. Therefore, when the user searches the document later by narrowing down the search for the document in each classification, sometimes the user cannot search the desired document, which results in a problem that the user cannot easily search the document.

### BRIEF SUMMARY OF THE INVENTION

An object of the invention is to provide a document managing apparatus and a document managing program in which the user can easily perform classifying operation of the documents.

According to one aspect of the present invention, there is provided a document managing apparatus comprising: a file managing unit which manages file managing information, a file of data being entered in the file managing information, the data constituting a document which is a managing target; a document managing unit which manages pieces of document managing information by arranging the pieces of document managing information in a particular order, the document managing information including classification information on at least classification attached to the document in a plurality of documents managed by the file managing unit; an extracting unit which extracts text data included in the document; an analyzing unit which analyzes whether a previously set text data string is included in the text data extracted by the extracting unit or not, the previously set text data string including the classification information attached to the document; a determining unit which determines whether the classification information is included or not based on the result of the analysis of the analyzing unit; an obtaining unit which obtains the classification information when the determining unit determines that the classification information is included; and an entering unit which enters the classification information while related to the document, the classification information being obtained by the obtaining unit, when the document obtaining the classification information is entered in the document managing unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing schematic configuration of a document managing system and a document managing apparatus according to an embodiment of the invention;

FIG. 2 shows a mouse according to the embodiment;

FIG. 3 shows a display example of a document searching screen according to the embodiment;

FIG. 4 shows a relationship between a document managed by the document managing apparatus according to the embodiment and an image displayed in an image display area;

FIG. 5 is a first file managing table according to the embodiment;

FIG. 6 is a second file managing table according to the embodiment;

FIG. 7 is a document managing table according to the embodiment;

FIG. 8 is another document managing table according to the embodiment;

FIG. 9 is still another document managing table according to the embodiment;

FIG. 10 is a color managing table according to the embodiment;

FIG. 11 is a flowchart for explaining a process of entering document managing information according to the embodiment;

FIG. 12 is a flowchart for explaining a classification information producing process in FIG. 11;

FIG. 13 is a flowchart for explaining an image generating process according to the embodiment;

FIG. 14 is a flowchart for explaining a process of displaying a document searching screen according to the embodiment;

FIG. 15 is a flowchart for explaining a document map generating process according to the embodiment;

FIG. 16 is a part of a flowchart for explaining a document searching process according to the embodiment;

FIG. 17 is another part of the flowchart for explaining the document searching process according to the embodiment; and

FIG. 18 is still another part of the flowchart for explaining the document searching process according to the embodiment.

### DETAILED DESCRIPTION OF THE INVENTION

Referring now to the accompanying drawings, an embodiment of the invention will be described in detail.

FIG. 1 is a block diagram showing schematic configuration of a document managing system and a document managing apparatus 1 according to an embodiment of the invention.

The document managing apparatus 1 includes a PC and the like. The PC is also connected an image input/output apparatus 2. Any image input/output apparatus 2 can be used as long as the image input/output apparatus 2 provides on image to the document managing apparatus 1 as the PC. Examples of the image input/output apparatus 2 include a scanner, a digital multi-function peripheral (MFP) provide with the scanner, a digital camera, and a computer on a network (for example, a WWW server).

As shown in FIG. 1, the document managing apparatus 1 includes a CPU 11, a RAM 12, a ROM 13, a network interface (I/F) 14, a hard disk drive (HDD) 15, a display device driver 16, a display device 17, a mouse driver 18, a mouse 19, a keyboard interface (I/F) 20, and a keyboard 21.

The CPU 11 controls the whole of the document managing apparatus 1. The CPU 11 realizes various functions by executing control programs stored in the ROM 13 and application programs stored in the HDD 15. The RAM 12 is a memory in which working data and the like are temporarily stored. The ROM 13 is a non-volatile memory in which a basic program to operate the document managing apparatus (PC) 1 and the like are previously stored.

The image input interface 14 is an interface to receive image data from the document managing apparatus 2. In the configuration shown in FIG. 1, the image input interface 14 functions as the interface to receive the image data from the image input/output apparatus 2. Although only one image input interface 14 is show in FIG. 1, it is also possible that plural image input interface 14 are provided in the document managing apparatus 1.

The HDD 15 is a storage device including a magnetic disk. Various kinds of data are stored in the HDD 15 in a file format. The data which constitute the document which is of a managing target of the document managing apparatus 1 is stored in the HDD 15 in the file format.

A first file managing table 23, a second file managing table 24, a document managing table 25, a color managing table 26, and the like are provided as a data table in the HDD 15.

The first file managing table 23 and the second file managing table 24 are tables in which managing information (file managing information) on the data file which constitutes the document of the managing target is stored. The document managing table 25 is the table in which managing information (document managing information) on the document of the managing target are stored. The color managing table 26 is the table in which information on the color related to the document of the managing target is stored. The data tables 23 to 26 will de described in detail later.

At least an application program (document managing program) 27 and setting information 28 are stored in the HDD 15. The application program 27 causes the PC to function as the document managing apparatus 1.

The document managing program 27 includes programs which cause the PC to execute various processes such as, a document managing information entering process, a classification information producing process an image generating process, a document searching screen displaying process, a document map generating process, and a document searching process. These processes will be described later. By performing the document managing program 27, the PC realizes various functions such as, a document managing information entering function, an classification information producing function an image generating function, a document searching screen displaying function, a document map generating function, and a document searching function.

The display device driver 16 includes a drive circuit which controls display contents of the display device 17. The display device driver 16 functions as the interface which outputs signals of the image displayed on the display device 17 to the display device 17. The mouse driver 18 includes a circuit which detects information inputted to the mouse 19. The mouse driver 18 detects motion of the mouse 19, input to a button provided in the mouse 19, a rotating amount of a wheel provided in the mouse 19, and the like. The mouse driver 18 informs the CPU 11 of the signals which indicate the motion of the mouse 19, the input to the button provided in the mouse 19, the rotating amount of the wheel provided in the mouse 19, and the like.

The keyboard interface 20 detects the information inputted to the keyboard 21 and informs the CPU 11 of the information The keyboard 21 includes plural keys such as characters, numerals, and symbols. The keyboard interface 20 detects the input to each key of the keyboard 21, and the keyboard interface 20 informs the CPU 11 of the signals which indicate the inputted key.

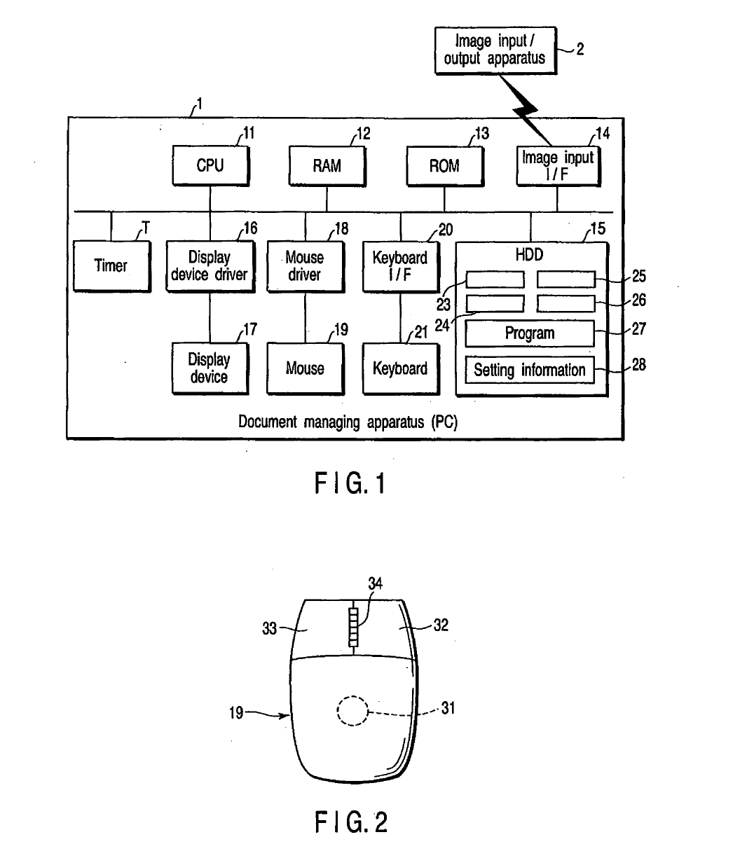

FIG. 2 shows a configuration of the mouse 19.

As shown in FIG. 2, the mouse 19 has a motion detecting mechanism 31, a right button 32, a left button 33, and a wheel 34. The mouse 19 is operated while placed on a plane as shown in FIG. 2. The mouse 19 shown in FIG. 2 is held by a user's hand. The user moves the mouse 19 on the plane as shown in FIG. 2, and the user operates the right button 32, the left button 33, and the wheel 34 as necessary.

The motion detecting mechanism 31 converts the motion of the mouse 19 on the plane into the signals. For example, the motion detecting mechanism 31 includes a sphere which is rotated according to the motion of the mouse 19 and a mechanism which converts the motion of the sphere into the signals. It is also possible that the motion detecting mechanism 31 includes an optical sensor which detects the motion of the mouse 19 on the plane and the mechanism which converts the mouse motion detected by the optical sensor into the signals. The motion detecting mechanism 31 is provided on the side which is in contact with the plane as shown in FIG. 2. When the user moves the mouse 19 with the mouse held in the state shown in FIG. 2, the motion detecting mechanism 31 detects the motion of the mouse on the plane. The signals which indicate the mouse motion detected by the motion detecting mechanism 31 is outputted to the mouse driver 18.

The right button 32 is one which is provided on the right side of a main body of the mouse 19 in the state shown in FIG. 2. When the user holds the main body of the mouse 19 shown in FIG. 2 by a right hand, the user operates the right button 32 by a forefinger or a middle finger of the user. The left button 33 is one which is provided on the left side of the main body of the mouse 19 in the state shown in FIG. 2. When the user holds the main body of the mouse 19 shown in FIG. 2 by the right hand, the user operates the left button 33 by the middle finger or a third finger of the user.

The wheel 34 is a rotating member which is provided near the central portion of the mouse 19 in is the state shown in FIG. 2. In FIG. 2, the wheel 34 is provided between the right button 32 and the left button 33. The user operates the wheel 34 by the forefinger, the middle finger, or the third finger of the user while holding the main body of the mouse 19 in the state shown in FIG. 2.

The wheel 34 is placed so as to be rotated only in a predetermined direction. In FIG. 2, the wheel 34 is rotated in the direction from the front side to the back side (from the lower side to the upper side in FIG. 2) and in the reverse direction (from the lower side to the upper side in FIG. 2). In the following description, with reference to the rotating direction of the wheel 34, the rotating direction in which the wheel 34 is rotated from the front side to the back side (from the lower side to the upper side in FIG. 2) shall mean a normal direction, and the rotating direction in which the wheel 34 is rotated from the back side to the front side (from the lower side to the upper side in FIG. 2) shall mean the reverse direction.

It is possible that the wheel 34 functions as the button. In this case, particular input is performed by pressing the wheel 34 down. Further, it is possible that the particular input is performed by pushing the wheel 34 down to the right or the left.

Then, the document displaying screen (document searching screen) managed by the document managing apparatus 1 will be described.

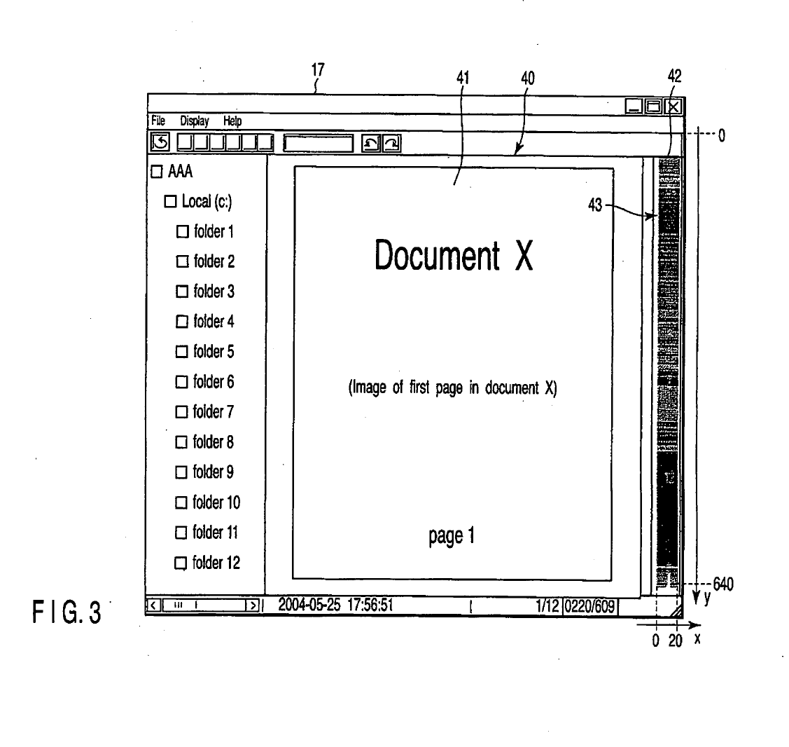

FIG. 3 shows a document searching screen (document displaying screen) 40 displayed on the display device 17 on the document managing apparatus 1.

In the document managing apparatus 1, the document searching screen 40 is displayed on a display window of the display device 17. In the document searching screen 40, as shown in FIG. 3, the image of each page which constitutes the document managed by the document managing apparatus 1 is displayed in unit of one page according to the user's operation. The user searches the desired document by referring to the image displayed on the document searching screen 40 shown in FIG. 3.

In FIG. 3, in addition to tool bars including various operation keys, an image display area 41, a document map (search bar) 42, an arrow 43, and the like are displayed on the document searching screen 40.

The image display area 41 is located in the substantial center of the display window as the document searching screen 40 displayed on the display device 17. The images of one or more pages which constitute the document are displayed in unit of page in the image display area 41 according to the user's operation.

The document map 42 is displayed on a right end area of the document searching screen 40. In the document map 42, a bar (line) which indicates each document managed by the document managing apparatus 1 is displayed while the documents are stacked on one another in the time-series order. The document map 42 shows the state in which the documents managed by the document managing apparatus 1 are stacked. In the document map 42 shown in FIG. 3, the uppermost bar indicates the document having the latest document time (newest document), and the lowermost bar indicates the document having the earliest document time (oldest document). Namely, in the document map 42 shown in FIG. 3, the stacked bar indicates the newer document when the bar is located at upper position, and the stacked bar indicates the older document when the bar is located at lower position.

The arrow 43 is displayed in the area adjacent to the document map 42 in the document searching screen 40. The arrow 43 indicates the position of the bar on the document map 42. The bar indicates the document to which the image, displayed in the image display area 41, belongs. Namely, the arrow 43 indicates the position of the bar which shows the displayed document on the document map 42.

In the document map 42, the bar corresponding to each document is displayed in a color corresponding to each document. The color of the bar corresponding to each document displayed in the document map 42 is set in each classification information stored in relation to the file of the data constituting the document. In this case, the documents to which the same classification information is related are displayed in the same color, and the documents to which the different classification information is related are displayed in the different color. Even if the folders are different from one another, the documents having the same classifications are displayed in the same color in the document map 40. Therefore, the user can intuitively recognize the classifications, in which the documents are stored, by the color displayed in the document map 42.

Then, the change of the image displayed in the image display area 41 of the document searching screen 40 will be described.

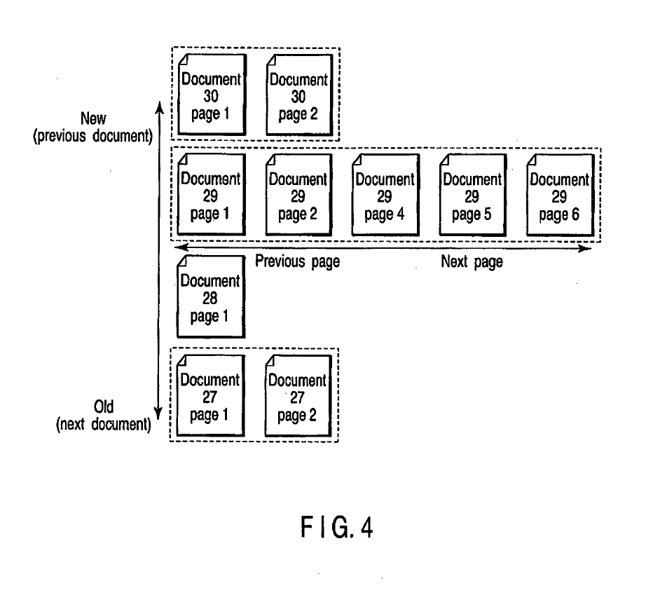

FIG. 4 shows a relationship between a document managed by the document managing apparatus 1 and the image displayed in the image display area 41.

Each document managed by the document managing apparatus 1 includes one or plural pages as shown in FIG. 4. The image displayed in the image display area 41 of the document searching screen 40 shown in FIG. 3 is configured to be changed in response to the input to the mouse 19 or the keyboard 21. The change of the image displayed in the image display area 41 includes the change of the document and the change of the page.

In the document managing apparatus 1, as shown in FIG. 4, the plural documents are managed in the time-series order based on the time when the document is produced or the time when the document is updated. The order of the documents is reflected in the display order of the bars corresponding to the documents which are displayed in the document map 42 while stacked. Accordingly, as shown in FIG. 3, the bars corresponding to the documents are displayed while stacked in the time-series order.

In the document managing apparatus 1, as shown in FIG. 4, the plural pages in each document are managed in the order of the page.

In the document managing apparatus 1, the document displayed in the document searching screen 40 is changed according to the operation of the mouse 19 or the keyboard 21 in the longitudinal direction (vertical direction in FIG. 3). Further, in the document managing apparatus 1, the page displayed in the document searching screen 40 is changed according to the operation of the mouse 19 or the keyboard 21 in the crosswise direction (horizontal direction in FIG. 3).

When the user performs the operation in the longitudinal direction with the mouse 19 or the keyboard 21, the document managing apparatus 1 changes the documents displayed in the image display area 41 of the document searching screen 40. As a result, the representative image (for example, the first page image in the document) of the document changed according to the user's operation in the longitudinal direction is displayed in the image display area 41 of the document searching screen 40. When the user performs the operation in the crosswise direction with the mouse 19 or the keyboard 21, the document managing apparatus 1 changes the pages displayed in the image display area 41 of the document searching screen 40. As a result, the image of the page changed according to the user's operation in the crosswise direction is displayed in the image display area 41 of the document searching screen 40.

The change of the image displayed in the image display area 41 of the document searching screen 40 in unit of document will be described below.

The user directs to change the document using an input device such as the mouse 19 and the keyboard 21. In this case, as described above, the document as the image displayed in the image display area 41 should be changed according to the operation in the longitudinal direction (vertical direction). For example, the document is changed according to the input to upward and downward cursor keys (upward key and downward key) of the keyboard 21 or the operation in the longitudinal direction by a pointing device such as the mouse 19. In the embodiment, the document is also changed according to the rotation of the wheel 34 of the mouse 19. The process of changing the document by the wheel 34 of the mouse 19 will be described in detail later.

When the document is changed by the above operation, the first page image is displayed as the representative image of the document in the image display area 41 of the document searching screen 40. Namely, the first page image in each document is displayed in the image display area 41 each time the document is changed with the mouse 19 and the keyboard 21. In is possible that the representative image of each document is set at the particular page in the pages of each document.

When the representative image (image of the first page) is changed in the document displayed in the image display area 41, the user directs to change the document using the input device such as the mouse 19 and the keyboard 21. Then, the document managing apparatus 1 changes the first page image of the document displayed in the image display area 41 in the time-series order.

The change of the image displayed in the image display area 41 of the document searching screen 40 in unit of page will be described below.

The user directs to change the page using the input device such as the mouse 19 and the keyboard 21. In this case, as described above, the page as the image displayed in the image display area 41 should be changed according to the operation in the crosswise direction. For example, the page is changed according to the input to rightward and leftward cursor keys (rightward key and leftward key) of the keyboard.

Each time the page is changed by the above operation, the image of each page which constitutes the document is sequentially displayed in the image display area 41 of the document searching screen 40. Namely, when the particular page in the particular document is displayed in the image display area 41, the user directs to change the document to display the first page image of the desired document in the image display area 41. In such a state, when the user directs to change the page using the mouse 19 or the keyboard 21, the document managing apparatus 1 displays the image of each page which constitutes the document in the image display area 41 in the order of the page.

The data tables 23 to 26 which manage the document in the document managing apparatus 1 having the above configuration will be described below.

In the document managing apparatus 1, the data which constitute each document of the managing target and the related information data are stored in the HDD 15 in the file format. The file of the data which constitutes the document stored in the HDD 15 is managed by the first file managing table 23 and the second file managing table 24. The file of the related information data is stored in a predetermined folder of the HDD 15. The document corresponding to the file stored in the HDD 15 is managed by the document managing table 25. The color of the bar which indicates each document in the document map 42 of the document searching screen 40 is managed by the color managing table 26.

The first file managing table 23 and the second file managing table 24 will be described below.

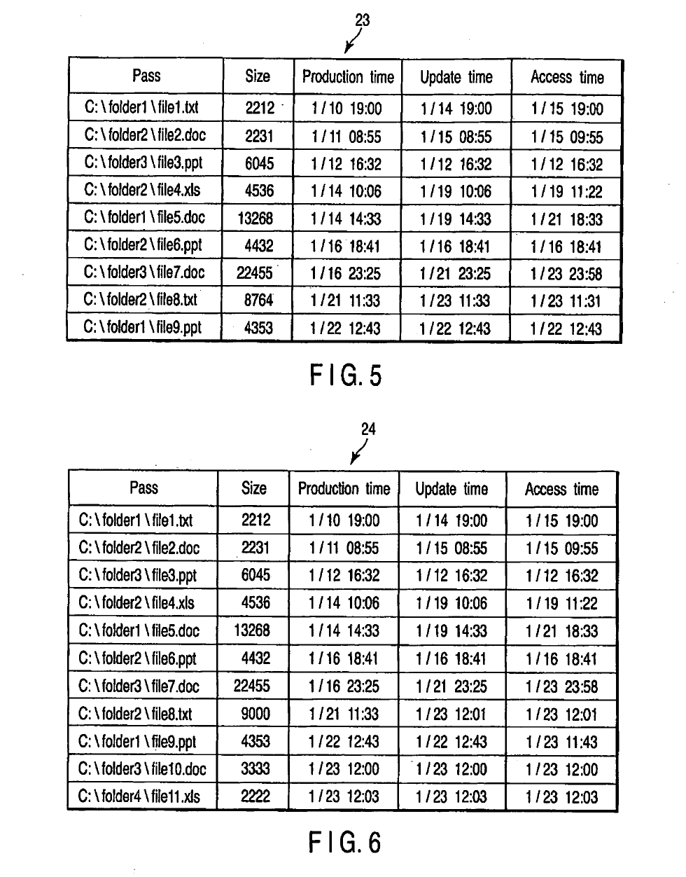

FIG. 5 shows a configuration of the first file managing table 23. FIG. 6 shows a configuration of the second file managing table 24.

The managing information on each file as each document managed by the document managing apparatus 1 is stored in the first file managing table 23 and the second file managing table 24.

As shown in FIGS. 5 and 6, the first file managing table 23 and the second file managing table 24 are configured so that the file managing information such as a pass, a size, a production time, an update time, and an access time is stored in the first file managing table 23 and the second file managing table 24.

The information which indicates a drive name and a folder name, in which the file exists, and the information which indicates a file name of the file are stored as the pass. The data size of the file is stored as the size. The date and time when the file is produced is stored as the production time. The date and time when the file is updated is stored as the update time. The latest date and time when access to the file is performed is stored as the access time.

The managing information of each file at a past point in time is stored in the first file managing table 23. The past point in time shall be the time when the document managing apparatus 1 is started up last time. On the other hand, a list of the current files is shown in the second file managing table 24. Accordingly, the second file managing table 24 is updated at any time according to the update and addition of the file.

For example, when the document managing apparatus 1 is started up, the information of the second file managing table 24 at this point is stored as the first file managing table, and the new second file managing table 24 is produced (updated). The managing information on the newly added file and the updated file is stored in the second file managing table 24. Namely, the difference between the file in the last-time start-up and the file in the present-time start-up is expressed as the difference between the first file managing table 23 and the second file managing table 24. In the embodiment, the update status of the file (new entry or update) is determined by the difference between the first file managing table 23 and the second file managing table 24.

As an example of the new entry of the file, it is assumed that the document managing apparatus 1 obtains the document including the images of the plural pages through the network interface 14. In this case, the data of the document obtained through the network interface 14 is stored as the new entry file in the HDD 15. At this point, a field in which the managing information on the new entry file is stored is added to the second file managing table 24, and the pass, the size, the production time, the update time, the access time, and the like are stored as the managing information of the new entry file. The information stored in the first file managing table 23 is held with no change.

As an example of the file update, it is assumed that the file having the managing information in the second file managing table 24 is updated. In this case, the updated file is stored by overwriting the already-existing file in the HDD 15. In the managing information oh the updated file in the second file managing table 24, the size, the update time, the access time, the header information, and the like are updated based on the updated file. The information stored in the first file managing table 23 is also held with no change.

Then, the document managing table 25 will be described.

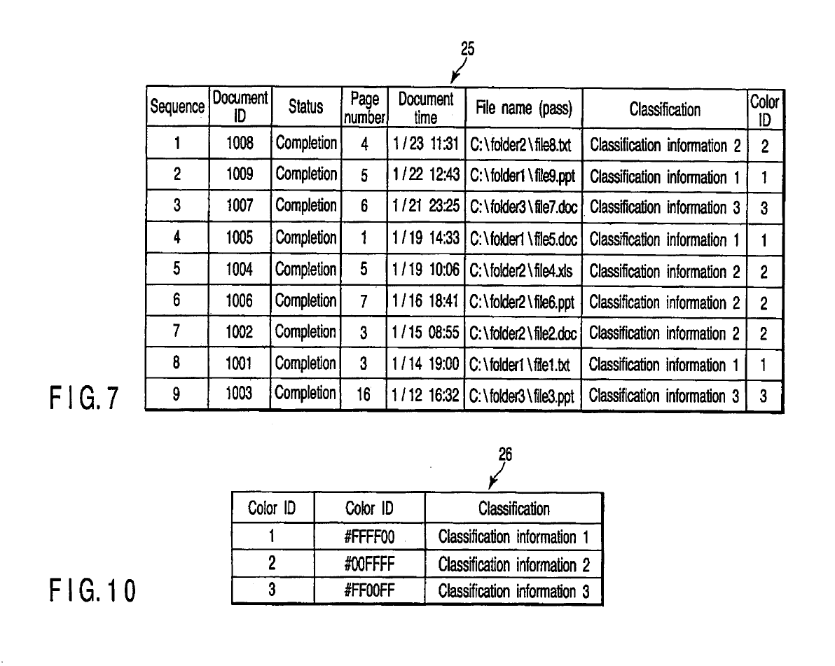

FIGS. 7, 8, and 9 show a configuration of the document managing table 25.

The document managing table 25 is one which manages the file, managed by the first file managing table 23, as the document. As shown in FIGS. 7, 8, and 9, in the document managing table 25, a sequence, the document ID, a status, the number of pages, a document time, the file name, a color ID, the classification information, and the like are stored as the managing information on the document.

The information which indicates the display order of each document is stored as the sequence. As described above, the documents are displayed in the time-series order based on the document time in the document searching screen 40 shown in FIG. 3. Accordingly, in the document managing table 25, the document time manages the sequence of the documents in the order of the time.

The unique ID information given to each document is stored as the document ID. The ID information identifies each document.

The information which indicates the processing status of each document is stored as the status. For example, the information which indicates “update” status or the information which indicates “completion” status is stored as the status. “Completion” means the status in which the update (update or new entry) of the document is completed. “Update” means the status in which the document waits for the update (update or new entry).

The information which indicates the number of pages of the document is stored as the number of pages. The number of pages is confirmed when the status of the document becomes “completion”.

The production time or the update time of each document is stored as the document time. For example, the update time of the file corresponding to the document managed by the first file managing table 23 is stored as the document time.

The information which indicates the file corresponding to the document is stored as the file name. For example, the drive name, the folder name, and the file name with respect to the file corresponding to each document are stored as the file name.

The classification information showing the classification attached to the document is entered as the classification information. The classification information is described as text data in the document by the user. For example, <tag>classification information(folder name)</tag> is described as the text data in the document. “<Tag>” is a text data string to detect the start of the classification information, and </tag> is the text data string to detect the end of the classification information. Thus, the classification information is produced by the later-mentioned classification information producing process based on the character string of the previously set text data including the classification information. Then, the classification information is entered in the classification which is an item in the document managing table 25 while related to the document.

The information which indicates the color to display the information showing each document is stored in the color ID. The color ID means the unique ID information given to each color to identify the color. The information which indicates the actual color corresponding to the color ID is shown by the color managing table 26.

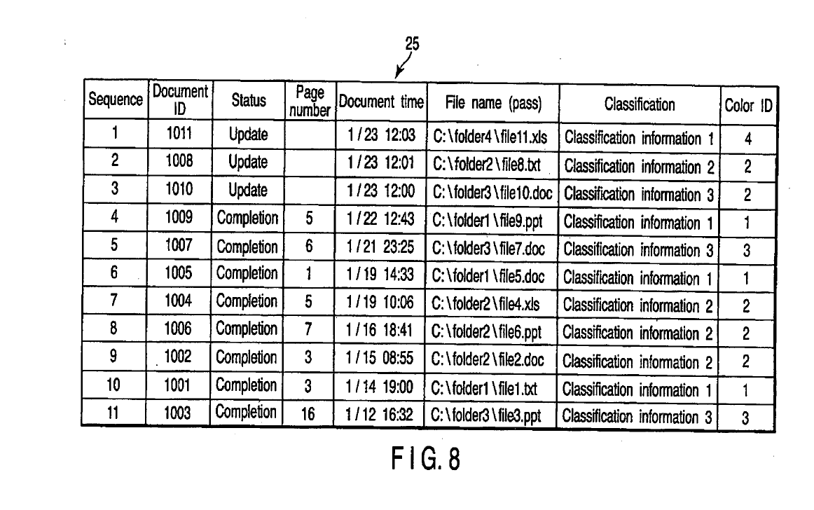

The document managing table 25 is updated by the process of entering the document managing information. For example, nine documents are managed in the document managing table 25 shown in FIG. 7. In such a state, the document having the document ID “1008” is updated, and the document having the document ID “1010” and the document having the document ID “1011” are newly added. In this case, in the later-mentioned process of entering the document managing information, three documents whose statuses are set at “update”, (document ID “1008”, document ID “1010”, and document ID “1011”) are entered in the document managing table 25 shown in FIG. 7. Then, the document managing table 25 shown in FIG. 8 is produced.

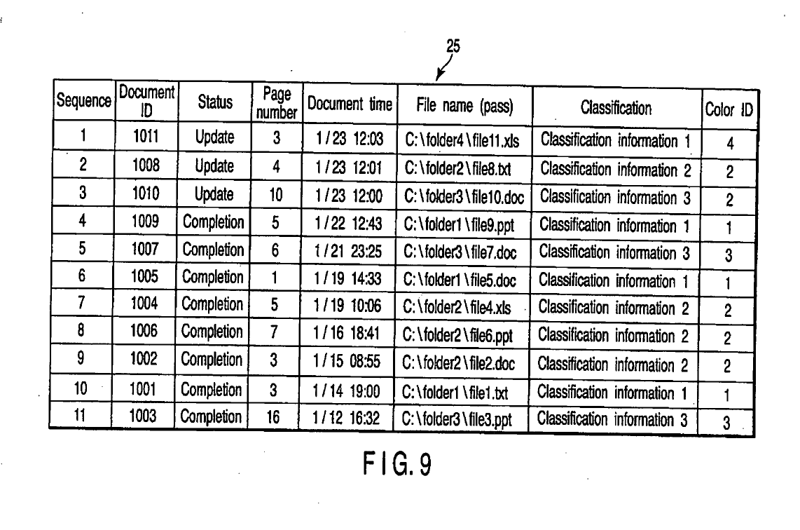

The statuses of the three documents of the document ID “1008”, the document ID “1010”, and the document ID “1011” are stored as “update” in the document managing table 25 shown in FIG. 8. As shown in FIG. 8, the later-mentioned image generating process is sequentially performed to the documents in which the status is set at “update” in the document managing table 25. In the document in which the image generating process is completed, the status is updated to “completion”. Accordingly, when the image generating process to the three documents of the document ID “1008”, the document ID “1010”, and the document ID “1011” is completed, the document managing table 25 shown in FIG. 8 is updated to the document managing table 25 shown in FIG. 9.

The number of pages of each document should be confirmed by the number of images generated by the image generating process, which will be described later. Therefore, in the document managing table 25, the number of pages of each document whose status is “update” becomes the blank field as shown in FIG. 8. For the document whose status is changed from “update” to “completion”, as shown in FIG. 9, the number of images generated by the later-mentioned image generating process is stored as the number of pages.

Then, the color managing table 26 will be described.

FIG. 10 shows a configuration of the color managing table 26.

The color managing table 26 is one in which the color ID, the color (information which indicates the actual color), and the classification information are correlated with one another. In the document managing table 25, as described above, the color corresponding to each document is shown by the color ID. Accordingly, the color corresponding to each document is determined by the color ID of the document managing table 25 and the color of the color managing table 26. The color corresponding to each document shall mean the color of the bar corresponding to each document displayed in the document map 42 of the document searching screen 40.

As described above, in the embodiment, the color of the bar corresponding to each document displayed in the document map 42 of the document searching screen 40 is set in each classification information. Accordingly, as shown in FIG. 10, the color ID and color which correspond to each classification information are stored in the color managing table 26.

Then, the process of entering the document managing information in the document managing apparatus 1 will be described.

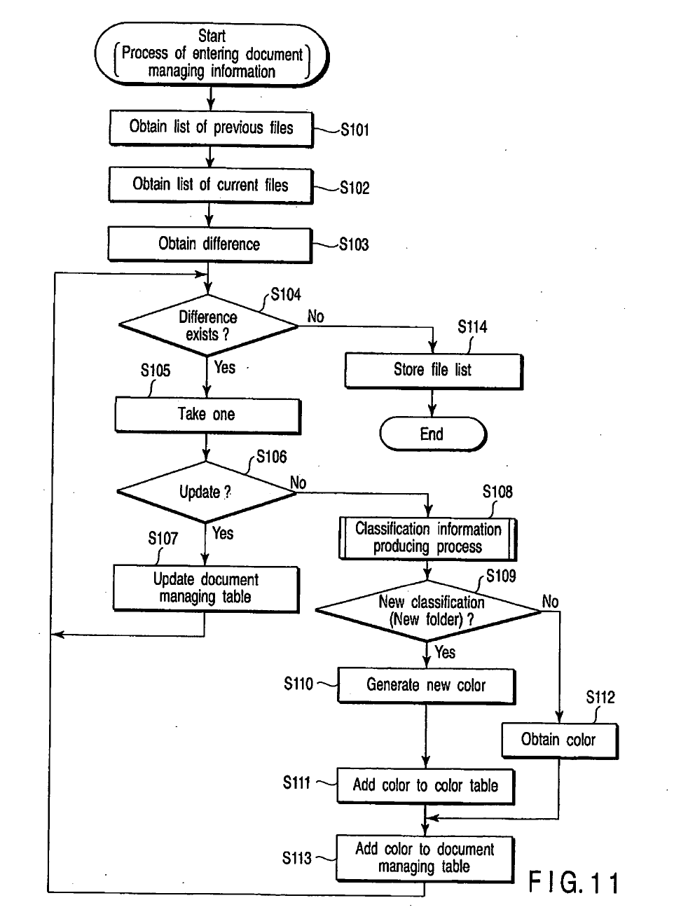

FIG. 11 is a flowchart for explaining the process of entering the document managing information in the document managing apparatus 1.

When the document managing apparatus 1 is started up, i.e. when the PC as the document managing apparatus 1 starts up the document managing program 27, the CPU 11 reads the first file managing table 23 in the HDD 15 as the file information of the previous time (Step S101). When the first file managing table 23 is read, the CPU 11 reads the second file managing table 24 in the HDD 15 as the current file information (Step S102).

When the first file managing table 23 and the second file managing table 24 are read, the CPU 11 performs a difference file detecting process (Step S103). The difference between the managing information (previous file information) of all the files stored in the first file managing table 23 and the managing information (current file information) of all the files stored in the second file managing table 24 is detected in the difference file detecting process. The information which indicates the difference file detected by the difference file detecting process is temporarily stored in, e.g. the RAM 12.

In the difference file detecting process, the updated file or the newly added file is extracted since the previous file information is produced. In the embodiment, the access time should not be set at the detecting target as the difference file.

It is determined that the file which does not exist in the previous file information but exist in the current file information, i.e. the file which exists only in the second file managing table 24 is the newly added file.

It is determined that the file in which the update time in the current file information differs from the update time in the previous file information, i.e. the file in which the first file managing table 23 differs from the second file managing table 24 in the update time is the updated file.

It is determined that the file which does not exist in the current file information but exist in the previous file information, i.e. the file which exists only in the first file managing table 23 is the deleted file.

For example, in the process of detecting the difference file between the first file managing table 23 shown in FIG. 5 and the second file managing table 24 shown in FIG. 6, three files whose file names are “file8.txt”, “file10.doc”, and “file11.xls” are detected as the difference file.

In this case, the file “file8.txt” whose pass is “C:\folder2\file8.txt” has the different update time. Therefore, it is determined that the file “file8.txt” is the updated file.

The file “file10.doc” whose pass is “C:\folder3\file10.doc” and the file “file11.xls” whose pass is “C:\folder4\file11.xls” exist only in the second file managing table 24. Accordingly, it is determined that the file “file10.doc” and the file “file11.xls” are the newly added file.

When the difference file is detected by the difference file detecting process (YES in Step S104), the CPU 11 sequentially reads the managing information of the detected difference file to perform the process of updating the document managing table 25 (Step S105 to Step S112). The document managing table 25 updating process is repeatedly performed until the process is completed for all the difference files detected by the difference file detecting process.

Namely, when the difference file detected by the difference file detecting process exists (YES in Step S104), the CPU 11 reads the managing information of the difference file detected by the difference file detecting process one by one (Step S105). When the CPU 11 reads one difference file, the CPU 11 determines whether the difference file is the updated file (file whose update time is changed) or the newly added file (Step S106).

When the CPU 11 determines that the read difference file is the updated file (YES in Step S106), the CPU 11 performs the process of updating the managing information corresponding to the file in the document managing table 25 (Step S107).

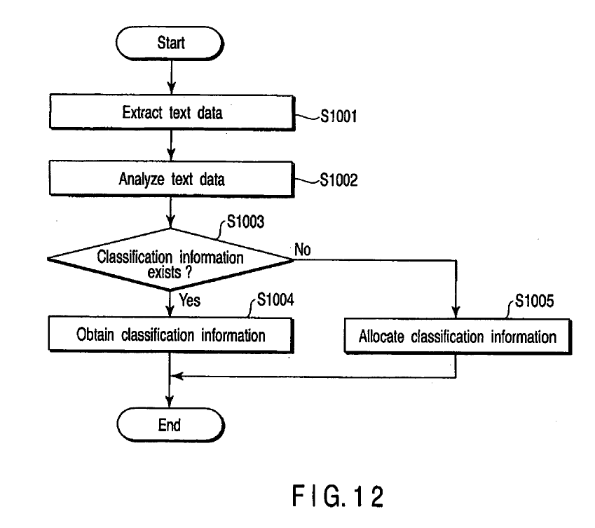

When the CPU 11 determines that the read difference file is not the updated file, i.e. when the CPU 11 determines that the difference file is the new file to be added (NO in Step S106), the CPU 11 performs the classification information producing process (Step S108). The classification information producing process will be described in detail later referring to a flowchart of FIG. 12.

The classification information of the document can be obtained by performing the classification information producing process. Then, the CPU 11 determines whether the classification information attached to the difference file is the new classification or not (Step S109). In Step S109, whether the classification information attached to the file is the classification information in which the color is managed by the color managing table 26 or not is determined, which determines whether the classification information is the new classification or not. Namely, it is determined that the classification information in which the color is set in the color managing table 26 is the already-existing classification information.

For the file whose pass is “C:\folder3\file10.doc”, the color is already allocated to the classification of classification information 3 in the color managing table shown in FIG. 10. In this case, it is determined that the classification of classification information 3 is not the new classification.

When the CPU 11 determines that the classification is the new classification (YES in Step S109), the CPU 11 generates the color allocated to the new classification (Step S110). For example, the new color which is not allocated to other classification yet is allocated to the new classification. The unique color ID is allocated to the generated color. When the color allocated to the new classification is generated, the CPU 11 adds color information on the new classification to the color managing table 26 (Step S111). In the color information, the color and the color ID correspond to the new classification.

When the CPU 11 adds the color information on the new classification in which the difference file is stored, the CPU 11 performs a new document adding process (Step S113). In the new document adding process, the managing information on the document corresponding to the difference file is added to the document managing table 25.

When the CPU 11 determines that the classification is not the new classification (NO in Step S109), the CPU 11 obtains the color ID allocated by the color managing table 26 to the folder in which the file is stored (Step S112). In this case, the CPU 11 performs the new document adding process in which the managing information on the document corresponding to the difference file is added to the document managing table 25 (Step S113).

In the new document adding process of Steps S112 and S113, referring to the second file managing table 24 and the color managing table 26, the managing information of the document corresponding to the newly added file is generated.

For example, the update time of the difference file is used as the document time in the managing information on the document. The pass of the difference file is used for the file name in the managing information on the document. Unique information newly generated is used as the document ID in the managing information on the document in order to distinguish the document from the already-existing document. The color ID of the color corresponding to the classification stored in the difference file is used as the color ID in the managing information on the document. However, the number of pages in the managing information on the document is left as the blank field, and the status in the managing information on the document is set at “update”. This is because the number of pages in the managing information on the document is confirmed when the image data is generated from the file through the later-mentioned image generating process.

When the difference file is not detected through the difference file detecting process, or when the process is completed to all the difference files detected by the difference file detecting process (NO in Step S104), the CPU 11 stores the information, currently stored in the second file managing table 24 as the start-up file information, in the first file managing table 23 (Step S114). Accordingly, the file information in performing the difference file detecting process (in this time start-up) is stored in the first file managing table 23, which allows the information stored in the first file managing table 23 to be used as the previous file information in the next start-up.

Thus, the managing information on the document corresponding to the updated file and the managing information on the document corresponding to the newly added file are entered in the document managing table 25 while the statuses are set at “update”. In the document whose status is “update”, the status is changed to “completion” by the later-mentioned image generating process, and the number of pages is confirmed.

Then, the classification information producing process in Step S108 will be described.

FIG. 12 is a flowchart for explaining the classification information producing process.

When the CPU 11 determines that the difference file is not the updated file in Step S106, the CPU 11 extracts the text data from the original data of the document (Step S1001). The CPU 11 analyzes whether the previously set text data string is included in the extracted text data or not (Step S1002). “<Tag>” and “</tag>” can be cited as examples of the previously set text data string as described above. Namely, the CPU 11 analyzes whether both “<tag>” of the text data string showing the front end of the classification information and “</tag>” showing the back end of the classification information are included in the extracted text data or not.

Based on the result of the analysis showing whether or not a previously set string of text data is included in the text data extracted from the document, the CPU 11 determines whether the classification information exists or not (Step S1003). Namely, the CPU 11 determines whether both “<tag>” of the text data string showing the front end of the classification information and “</tag>” of the text data string showing the back end of the classification information are detected or not.

When the CPU 11 determines that the previously set text data exists (YES in Step S1003), the CPU 11 obtains the classification information from the extracted text data (Step S1004). Specifically, the CPU 11 obtains the text data located between “<tag>” of the text data string and “</tag>” of the text data string as the classification information.

On the contrary, when the CPU 11 determines that the previously set text data is not included in the text data extracted from the document, the CPU 11 allocates the previously set classification information to the document (Step S1005). In the previously set classification information allocated to the document, for example, new unclassified items are sequentially increased like an unclassified item 1, an unclassified item 2, . . . , and an unclassified item N. Accordingly, in the case where the document which cannot obtain the classification information exists, for example “unclassified 1” is stored in the classification which is the item of the document managing table 25. It is possible that all the pieces of previously set classification information allocated to the document are set at “unclassified”. It is also possible that the folders are classified, or it is possible that file types are classified.

The classification information of the document can always be obtained by performing the classification information producing process.

Then, the process of generating the document image will be described.

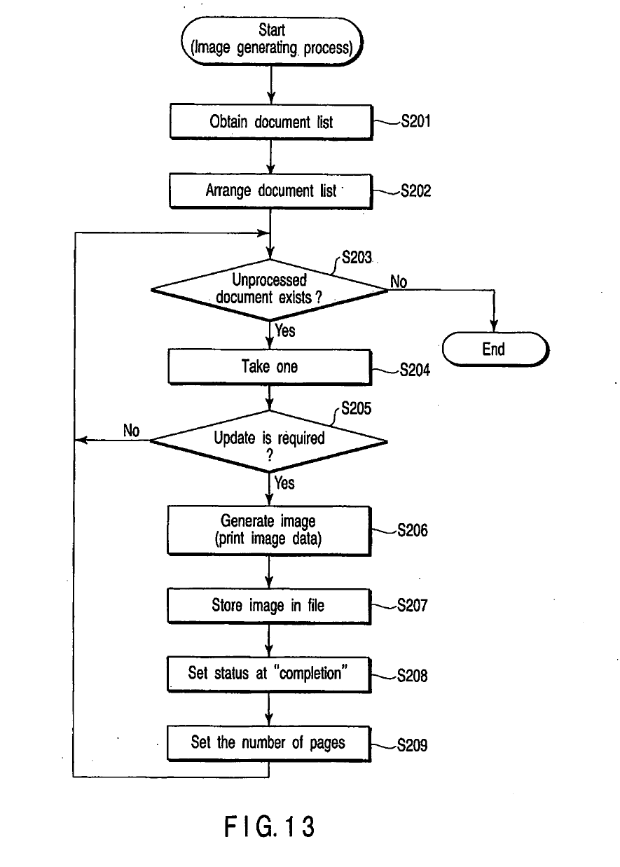

FIG. 13 is a flowchart for explaining the image generating process.

In the document managing information entering process, the pieces of managing information on the document corresponding to the updated file and the newly entered file are entered in the document managing table 25 while the statuses are “update”. In the file whose status is “update”, the display image is not generated. Therefore, for the document whose status is “update”, it is necessary to generate the display image. The process of generating the display image of the document is referred to as image generating process.

When the document managing information entering process is completed, the CPU 11 performs the process of generating the display image. When the image generating process is started up, the CPU 11 reads all the pieces of managing information on the documents from the document managing table 25 (Step S201). When the managing information on the document is read from the document managing table 25, the CPU 11 sorts all the pieces of managing information on the documents based on the document time in the managing information on each document (Step S202). Therefore, in the document managing table 25, all the pieces of managing information on the documents are rearranged in the order of the document time (time-series order). For example, in FIG. 8, the latest three documents are the status of “update”.

When all the pieces of managing information on the documents in the document managing table 25 are sorted based on the document time, the CPU 11 determines whether the document (unprocessed document) to which the image generating process is not performed exists or not (Step S203). When the CPU 11 determines that the unprocessed document exists, the CPU 11 reads the managing information on the unprocessed document in each document (Step S204).

When the CPU 11 reads the managing information on one unprocessed document, the CPU 11 determines whether the status of the managing information on the document read is “update” or not (Step S205). When the CPU 11 determines that the status is “update” (YES in Step S205), the CPU 11 performs the process of generating the display image of the document (Step S206).

In the image generating process, a bitmap image of each page which constitutes the document should be generated as the display image of the document. In the embodiment, the display image data of the document should be produced as print image data. The data of each document is formed by text data or the data in various formats such as the image data.

In the document managing apparatus 1, the document including the pieces of various formats should the managing target. Therefore, in the document managing apparatus 1, the data of each page which constitutes the document is generated as the print image data. Usually, in the pieces of data of various formats used in various application programs, the print image is produced in the application program. For example, when the document is the text data, the display image of the document is generated as the print image by the application program of a word processor.

When the display image data is generated by the image generating process, the CPU 11 stores the image of each page (display image data of each page) which constitutes the document in the form of the image data file in the HDD 15 (Step S207). Therefore, the image data file of the number of the pages of the document is stored in the HDD 15. When the image data file of each page of the document is stored in the HDD 15, the CPU 11 changes the status to “completion” in the managing information on the document in the document managing table 25 (Step S208). The CPU 11 specifies the number of pages from the number of files generated as the image data, and the CPU 11 sets the number of pages as the managing information on the document in the document managing table 25 (Step S209).

When the unprocessed document becomes nonexistent, i.e. when the statuses of all the documents become “completion” in the document managing table 25 (No in Step S203), the CPU 11 ends the image generating process.

As described above, in the embodiment, display image data of each document is generated as one file in each page of the document. The display image data of each document may be generated in any format such as TIF and PDF. A JPEG format is used in the embodiment.

However, in each file of the display image data as the image of each page, the file name should be specified from the document ID and a page number. For example, the file of the display image data is stored in each name of “document ID-page number.jpg”.

In the document managing table 25 shown in FIG. 8, the document of “C:\folder4\file11.xls” is formed by the images of three pages. In this case, in the process of generating the display image for the document of “C:\folder4\file11.xls”, the pieces of display image data of three pages (three image data files in JPEG format) are generated.

As shown in FIG. 8, the document ID is “1011” in the document of “C:\folder4\file11.xls”. Therefore, the three files of “1011-001.jpg”, “1011-002.jpg”, and “1011-003.jpg” are generated as the display image data of the document “C:\folder4\file11.xls”.

In the managing information on the document whose document ID in document managing table 25 shown in FIG. 8 is “1011”, the status is set at “completion”, and the number of pages is set at “three” as shown in FIG. 9. FIG. 9 shows an example of the document managing table 25 when the image generating process is completed for the document managing table 25 shown in FIG. 8.

It is possible that the image generating process is performed in parallel with another process. Namely, it is possible that the image generating process is performed in the background of another process. For example, in the case where there are many documents whose statuses are “update”, or in the case where the number of pages of the document whose status is “update” is large, there is a possibility that it takes a long time to perform the image generating process. Therefore, even if the image generating process is being performed, it is also possible that the CPU 11 performs the later-mentioned process of displaying the document searching screen 40.

Then, the process of displaying the document searching screen (document searching display window) 40 will be described.

FIG. 13 is a flowchart for explaining a display process of the document searching screen 40.

When the document searching screen 40 is displayed (started up), the CPU 11 reads the pieces of managing information of all the documents stored in the document managing table 25 (Step S301). When the CPU 11 reads the pieces of managing information of all the documents stored in the document managing table 25, the CPU 11 arranges the pieces of managing information of all the documents read in the order of the latest document time (time-series order) (Step S302).

After the CPU 11 arranges the pieces of managing information of all the documents read in the time-series order, the CPU 11 reserves a storage area of the current document (display document) on the RAM 12. An information which indicates the currently displayed document is stored in the storage area of the current document. After the storage area of the current document is reserved, the CPU 11 sets the information which indicates the latest document in the storage area of the current document (Step S303). At this point, “order” stored as the managing information on the document in the document managing table 25 should be set as the information which indicates the current document at the storage area of the current document. Namely, the CPU 11 displays the currently displayed document (current document) in the “order” given to each document.

Further, the CPU 11 reserves a storage area of the current page (display page) on the RAM 12. An information which indicates the number of pages of the currently displayed document is stored in the storage area of the current page. After the storage area of the current page is reserved, the CPU 11 sets the information which indicates the representative page (first page in the embodiment) of the document in the storage area of the current page (Step S304). At this point, the number of pages should be set as the information which indicates the current document at the storage area of the current page.

Namely, the CPU 11 displays the representative page (first page) of the latest document as the initial display image. Therefore, the CPU 11 sets the current document at “1”, and sets the current page at “1”. When the CPU 11 sets the current document at “1”, and sets the current page at “1”, the CPU 11 obtains the display image data file of the page (the “1”-st page image in the document whose order is “1”) (Step S305).

In the image obtaining process, the image data file of the page to be displayed referring to the document managing table 25 is specified. Namely, the CPU 11 refers to the document managing table 25 to obtain the document ID corresponding to “order” (“1” in this case) set at the current document. After the CPU 11 obtains the document ID of the current document, the CPU 11 specifies the image data file including the document ID and the page number of the current document from “page number” (“1” in this case) set at the current page.

For example, in the document managing table 25 shown in FIG. 9, the document ID whose order is “1” is “1011”. The image file of the first page of the document ID “1011” is stored in the name of “1011-001.jpg”. Accordingly, in the case where the current document is set at “1” and the current page is set at “1”, the CPU 11 refers to the document managing table 25 shown in FIG. 9 to specify “1011-001.jpg” as the image data file.

After the image data file is obtained by the image obtaining process, the CPU 11 displays the image data of the file in the image display area 41 of the document searching screen 40 (Step S306). After the obtained image data is displayed in the image display area 41, the CPU 11 performs a document map generating process (Step S307). In the document map generating process, the document map 42 showing all the documents in the time-series order is generated. The document map generating process will be described later.

After the document map 42 is created by the document map generating process, the CPU 11 displays the generated document map 42 in a predetermined display area in the document searching screen 40 (Step S308). When the document map 42 is displayed in the document searching screen 40, the CPU 11 specifies the position of the current document in the document map 42 (Step S309). After the position of the current document is specified, the CPU 11 displays the arrow 43 which indicates the position of the current document on the document map 42 (Step S310).

The initial screen is displayed as the document searching screen 40 in the display window on the display device 17 by the document searching screen displaying process.

Then, the document map generating process will be described.

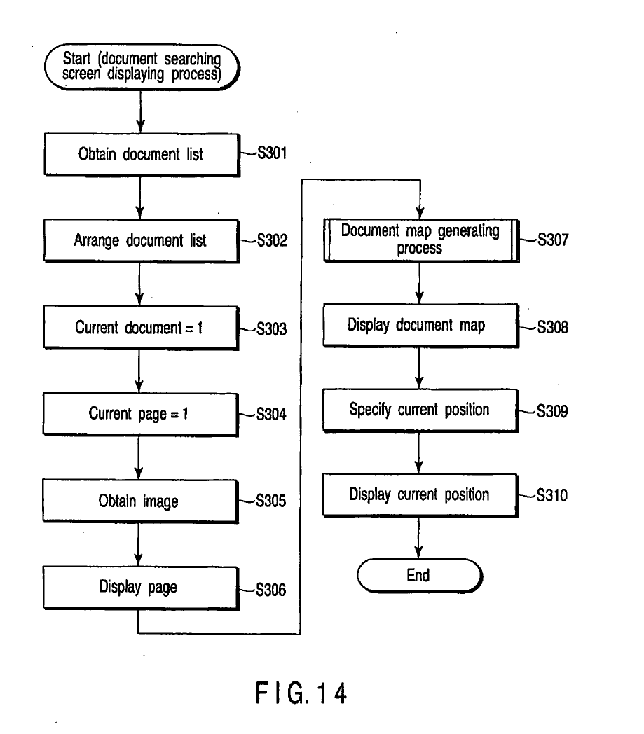

FIG. 14 is a flowchart for explaining the document map generating process.

When the process of generating the document map 42 is started, the CPU 11 reserves the display area to display the document map 42 in the document searching screen 40 (Step S401). The display area of the document map 42 should previously be set. In Step S401, the CPU 11 should display the reserved display area of the document map 42 in the color such as white as an initial value.

For example, as shown in FIG. 3, the display area of the document map 42 is set at the area having the size of a 20-pixel width and a 640-pixel height on the right end of the document searching screen 40. Assuming that the rectangle area is shown by coordinates (X,Y) of (0,0), (20,0), (0,640), and (20,640) as shown in FIG. 3, the display area of the document map 42 will be described.

After the display area of the document map 42 is reserved in the document searching screen 40, the CPU 11 sets an initial coordinate where imaging is started (Step S402). In this case, the initial coordinate is set at the uppermost end in the display area of the document map 42, and a Y-coordinate is set at “0” (Y=0).

After setting the initial coordinate, the CPU 11 reads the managing information on the document from the document managing table 25 in the order in which “order” is increased. Namely, the CPU 11 determines whether the document (not-yet-imaged document) in which the bar is not imaged in the display area of the document map 42 exists in the document managing table 25 or not. When the CPU 11 determines that the not-yet-imaged document exists in the document managing table 25 (Step S403), the CPU 11 reads the managing information on the document having the smallest “order” number in the not-yet-imaged documents (Step S404).

When the managing information on the document is read, the CPU 11 specifies the color ID allocated to the read document (Step S405). After the color ID of the document is specified, the CPU 11 refers to the color managing table 26 to confirm the actual color corresponding to the color ID of the document (Step S406). Therefore, the bar (line) which indicates the document in the document map 42 is imaged by the confirmed color.

After the color of imaging bar which indicates the document is specified, the CPU 11 images the bar (line) which indicates the document with the confirmed color at the current coordinate in the display area of the document map 42 (Step S407). The bar which indicates each document should be the line having the width (height) of one pixel in the Y-direction. In this case, for the first document, the bar having the width (height) of one pixel at the Y-initial coordinate ((0,Y) to (20,Y)) is imaged in the display area of the document map 42.

After the bar which indicates the document is imaged, the CPU 11 increments the coordinate in the Y-direction by one pixel by setting “Y=Y+1” (Step S408). When the CPU 11 increments the coordinate in the Y-direction by one pixel, the CPU 11 determines whether the coordinate in the Y-direction exceeds the display area of the document map 42 or not. When the CPU 11 determines that the coordinate in the Y-direction exceeds the display area of the document map 42 (YES in Step S409), the CPU 11 ends the process of generating the document map 42.

When the CPU 11 determines that the coordinate in the Y-direction does not exceed the display area of the document map 42 (NO in Step S409), the CPU 11 returns to Step S403. The CPU 11 repeats Steps S403 to S409 until the not-yet-imaged document does not exist in the display area of the document map 42. Namely, the processes of Steps S403 to S409 are repeatedly performed to all the documents managed by the document managing table 25.

The document map 42, in which the bar that indicates each document is displayed in the color corresponding to each document while stacked in the time-series order, is generated by the above-described processes.

Then, the document searching process will be described.

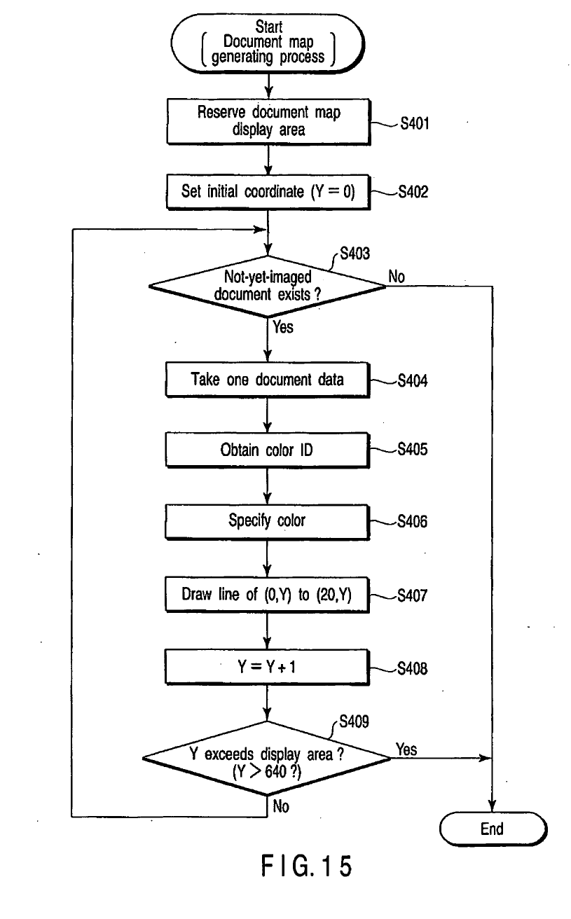

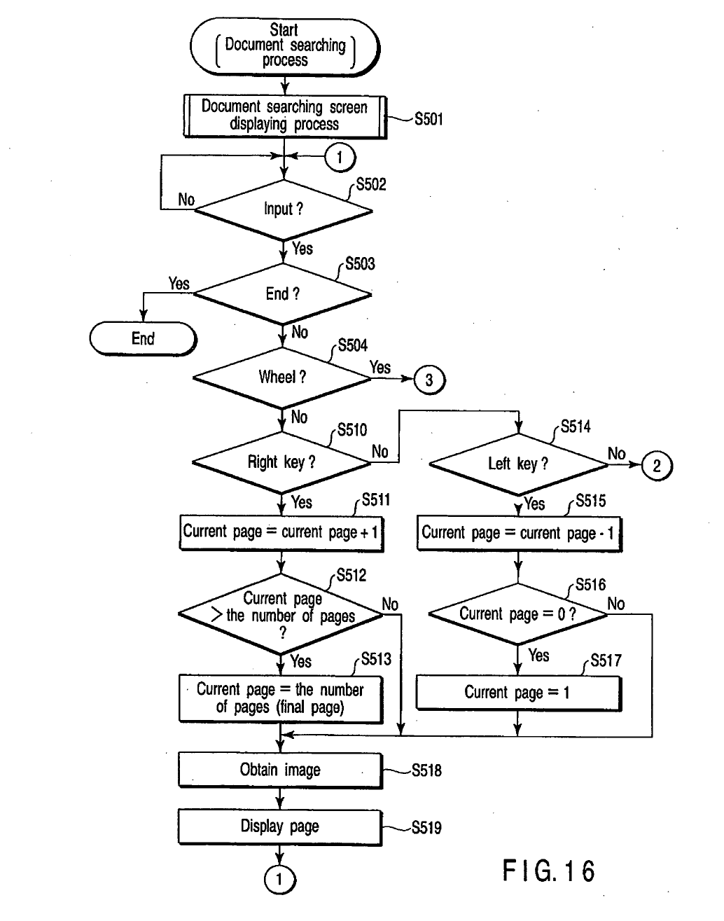

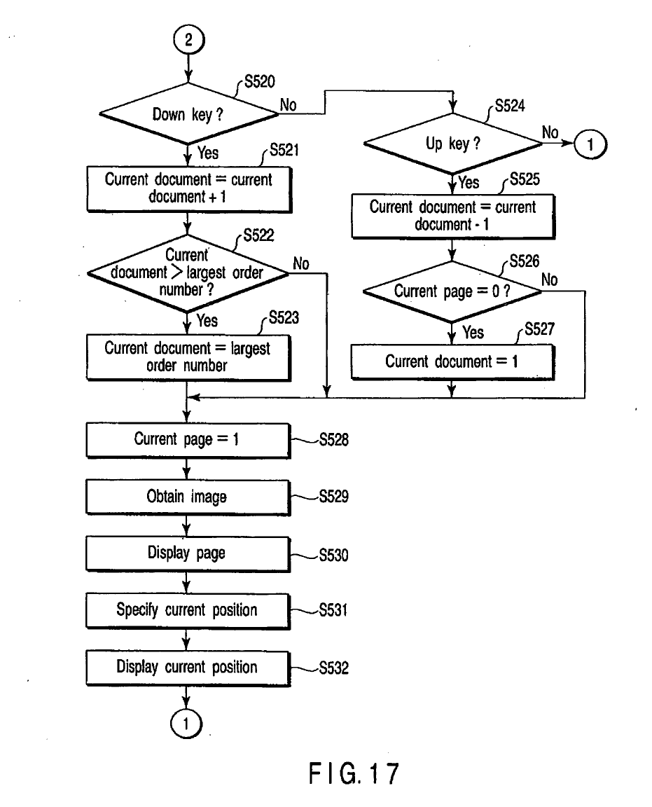

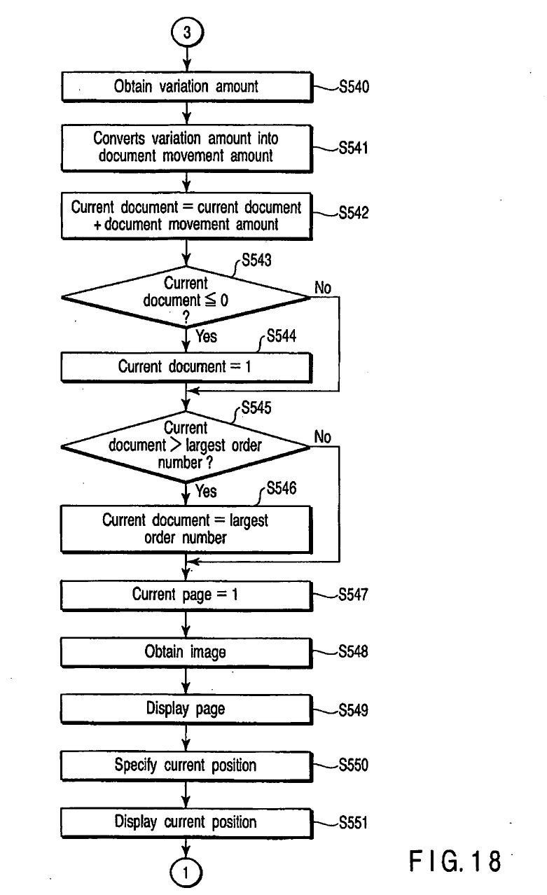

FIGS. 15, 16, and 17 are flowcharts for explaining the document searching process.

At first the document searching screen 40 should be displayed on the display device 17 by the process of displaying the document searching screen. The first page image of the new document having the latest document time is displayed in the document searching screen 40 (Step S501). Because the process in Step S501 is the same as the one shown in FIG. 14, the description and the flowchart of the sub flow will not be described.

In such a state, the CPU 11 waits for the user's input with the mouse 19 or the keyboard 21 (Step S502). Namely, the CPU 11 detects the presence or absence of the input to the mouse 19 or the keyboard 21. In the input to the wheel 34 of the mouse 19, the rotating amount of the wheel 34 in a predetermined time is inputted as a variation amount. In the input to each key of the keyboard 21 or the right and left buttons 32 and 33 of the mouse 19, the CPU 11 detects which key is inputted.

When the CPU 11 detects the input to the mouse 19 or the keyboard 21 (YES in Step 502), the CPU 11 determines whether contents of the inputted direction are an end direction or not (Step S503). When the CPU 11 determines that the contents of the inputted direction are the end direction (YES in Step S503), the CPU 11 turns off the document searching screen 40 and ends the process.

When the CPU 11 determines that the contents of the inputted direction are not the end direction (NO in Step S503), the CPU 11 determines whether the contents of the inputted direction are the input to the wheel 34 of the mouse 19 or not (Step S504).

When the CPU 11 determines that the contents of the inputted direction are not the input to the wheel 34 of the mouse 19 (YES in Step S504), the CPU 11 determines whether the contents of the inputted direction are the input to the right key giving the direction of the rightward movement (Step S510), whether the contents of the inputted direction are the input to the left key giving the direction of the leftward movement (Step S514), whether the contents of the inputted direction are the input to the down key giving the direction of the downward movement (Step S520), and whether the contents of the inputted direction are the input to the up key giving the direction of the upward movement (Step S524). When the keys except for the right key, the left key, the down key, and the up key are inputted, the CPU 11 returns to Step S502, and the CPU waits for the input again.

When the CPU 11 determines that the input is the right key (YES in Step S510), the CPU 11 increments the current page by one to set at “current page=current page+1” (Step S511). In this case, the CPU 11 obtains the number of pages of the current document from the document managing table 25, and the CPU 11 confirms whether the current page set in Step S511 exceeds the number of pages of the current document (Step S512). When the CPU 11 determines that the current page set in Step S511 exceeds the number of pages of the current document, the CPU 11 sets the current page at the number of pages of the current document, i.e. the final page of the current document (Step S513).

When the CPU 11 determines that the input is the left key (YES in Step S514), the CPU 1 decrements the current page by one to set at “current page=current page−1” (Step S515). In this case, the CPU 11 confirms whether the current page to be displayed is “0” or not (Step S516). When the CPU 11 determines that the current page set in Step S515 is “0”, the CPU 11 sets the current page at “1”, i.e. the first page of the current document (Step S517).

When the current page is changed through Steps S510 to S517, the CPU 11 obtains the document ID of the current document based on the corresponding relationship between “order” and “document ID” in the document managing table 25. When the document ID of the current document is obtained, the CPU 11 obtains the image file of the page by the document ID and the current page of the current document (Step S518). After the CPU obtains the image file of the page, the CPU 11 displays the image of the page in the image display area 41 of the document searching screen 40 (Step S519).

When the CPU 11 determines that the input is the down key (YES in Step S520), the CPU 11 increments the current document by one to set at “current document=current document+1” (Step S521). In this case, the CPU 11 obtains the largest order number (“order” of the document having the oldest document time) from the document managing table 25, and the CPU 11 confirms whether the current document set in Step S521 exceeds the largest order (Step S522). When the CPU 11 determines that the current document set in Step S522 exceeds the largest order, the CPU 11 sets the current document at the largest order number, i.e. the document having the oldest document time (Step S523).

When the CPU 11 determines that the input is the up key (YES in Step S524), the CPU 11 decrements the current document by one to set at “current document=current document−1” (Step S525). In this case, the CPU 11 confirms whether the current document set in Step S525 is “0” or not (Step S526). When the CPU 11 determines that the current document set in Step S525 is “0”, the CPU 11 sets the current document at “1”, i.e. the CPU sets the current document at the document having the latest document time (Step S527).

When the current document is changed through Steps S520 to S527, the CPU 11 sets the current page at “1” as the representative page of each document (Step S528). Therefore, when the current document and the current page are set, the CPU 11 obtains the document ID of the current document based on the corresponding relationship between “order” and “document ID” in the document managing table 25. When the document ID of the current document is obtained, the CPU 11 obtains the image file of the page by the document ID and the current page of the current document (Step S529). After the CPU 11 obtains the image file of the page, the CPU 11 displays the image of the page in the image display area 41 of the document searching screen 40 (Step S530).

Further, the CPU 11 specifies the position of the current document in the document map 42 in the document searching screen 40 (Step S531). When the position of the current document is specified, the CPU 11 displays the arrow 43 which indicates the position of the current document in the document map 42 (Step S532). It is also possible that the processes of Steps S531 and S532 are performed in parallel with the processes of Steps S528 to S530.

When the CPU 11 determines that the input to the wheel 34 of the mouse 19 exists (YES in Step S504), the CPU 11 obtains the rotating amount of the wheel 34 in the predetermined time as the variation amount (Step S541). The mouse driver 18 detects the rotating amount of the wheel 34. The mouse driver 18 informs the CPU 11 of the detected rotating mount of the wheel 34. Therefore, the CPU 11 is configured to obtain the rotating amount of the wheel 34 in the predetermined time as the variation amount.

After the CPU 11 obtains the variation amount, the CPU 11 converts the obtained variation amount into a document movement amount (Step S504). The document movement amount shall mean the number of documents which are changed in the display (the number of documents moved). The document movement amount should indicate the direction of the document movement. The relationship among the rotating amount of the wheel 34, the variation amount, and the document movement amount will be described in detail later.

In this case, the document movement amount is set at a positive value when the wheel 34 is rotated in a normal direction, and the documents are moved in the order of “order” of the documents in the movement direction. The document movement amount is set at a negative value when the wheel 34 is rotated in a reverse direction, and the documents are moved in the reversal order of “order” of the documents in the movement direction.

When the variation amount based on the rotating amount inputted to the wheel 34 is converted into the document movement amount (Step S541), the CPU 11 sets the current document at the document (current document=current document+document movement amount) which is moved by the document movement amount (Step S542). In this case, the CPU 11 confirms whether the current document set in Step S542 is not more than “0” or not (Step S543). When the CPU 11 determines that the current document set in Step S542 is “0” or less (YES in Step S543), the CPU 11 sets the current document at “1”, i.e. at the document having the latest document time (Step S544).

When the CPU 11 determines that the current document set in Step S542 is more than “0” (NO in Step S543), the CPU 11 further obtains the largest order number (“order” of the document having the oldest document time) from the document managing table 25, and the CPU 11 confirms whether the current document set in Step S542 exceeds the largest order (Step S545). When the CPU 11 determines that the current document set in Step S542 exceeds the largest order (YES in Step S545), the CPU 11 sets the current document at the largest order number, i.e. the document having the oldest document time (Step S546).

When the current document is changed through Steps S540 to S546, the CPU 11 sets the current page at “1” as the representative page of each document (Step S547). Therefore, when the current document and the current page are set, the CPU 11 obtains the document ID of the current document based on the corresponding relationship between “order” and “document ID” in the document managing table 25. When the document ID of the current document is obtained, the CPU 11 obtains the image file of the page by the document ID and the current page of the current document (Step S548). After the CPU obtains the image file of the page, the CPU 11 displays the image of the page in the image display area 41 of the document searching screen 40 (Step S549).

Further, the CPU 11 specifies the position of the current document in the document map 42 in the document searching screen 40 (Step S550). When the position of the current document is specified, the CPU 11 displays the arrow 43 which indicates the position of the current document in the document map 42 (Step S551). It is also possible that the processes of Steps S550 and S551 are performed in parallel with the processes of Steps S547 to S549.

In the above processes, the variation amount according to the rotating amount of the mouse wheel inputted by the user is converted into the document movement amount to change the document which displays the first-page image on the display device according to the document amount movement, which allows the document that displays the first-page image to be efficiently changed by rotating the wheel 34 of the mouse 19. As a result, the user can efficiently search the document managed by the document managing apparatus 1, and easily find out the desired document.

Then, the relationship among the rotating amount of the wheel 34 of the mouse 19, the variation amount, and the document movement amount will be described.

The relationship between the rotating amount of the wheel 34 of the mouse 19 and the document movement amount obtained by the CPU 11 is previously set by the setting information and the like. The relationship between the variation amount and the document movement amount, which are obtained by the CPU 11, is also previously set by the setting information and the like. The user can change the pieces of setting information to an arbitrary value.

For example it is assumed that the variation amount is set at “2880” for one rotation of the wheel 34 of the mouse 19. In this case, when the number of documents moved is set at “1” for the variation amount of “1”, the 2880 documents are moved with respect to the one rotation of the wheel 34. This means that, in the image (image of the representative page of each document) displayed in the image display area 41, the images of 2880 documents are changed by one rotation of the wheel 34.

In this case, because the movement amount of the document displayed in the image display area 41 is too large, the user hardly searches the desired document. Therefore, the number of documents moved is set at “1” for the variation amount of “120”. Then, the 24 documents are moved with respect to one rotation of the wheel 34, so that the user can easily search the desired document.

Then, the operation will be described when the user uses the document managing apparatus 1 having the above configuration.

At first, the operation will be described when the user enters the document in the document managing apparatus 1. The user inputs the previously set text data string including the classification information at any one of positions in the document, when the user produces the document with the document managing apparatus 1. For example, when the user wants to attach “patent” as the classification to the newly produced document, the user previously inputs the characters of “<tag>patent</tag>” in the document. When the document is entered by the process of entering the document managing information, the document is entered in relation to the classification of “patent”. Specifically, when the document is entered in the document managing table 25 by the document managing information entering process, “patent” is entered in the item showing the classification while related to the document ID. Further, simultaneously the color showing the classification of “patent” is also entered in the document managing table 25 while related to the document ID.

When the classification is not described in the entered document, the classification at which the document is previously set, e.g. “unclassified 1” is entered in relation to the document. Specifically, when the document is entered in the document managing table 25 by the document entering process, “unclassified 1” is entered in the item showing the classification while related to the document ID. Further, simultaneously the color showing the classification of “unclassified 1” is also entered in the document managing table 25 while related to the document ID.

Then, the operation will be described when the user operates the document managing apparatus 1 to search the document which is managed by the document managing table 25 while the classification is allocated to each document.

When the user operates the mouse 19 or the keyboard 21 to start up a display window on the display device 17 in order to search the document, the first page of the latest document in the time-series order is displayed in the document searching screen 40. The document map 42 of the documents less than 640 managed by the document managing table 25 from the documents displayed in the document searching screen 40 are displayed near the document searching screen 40. The document map 42 has the rectangular shape. In FIG. 3, the document map 42 is displayed in the time-series order by the bar (line) so that the documents are displayed in the same color in each classification attached to the document. Therefore, the user can visually recognize the position of the document in each classification by the display of the document map 42.

The bar (line) of the document map 42 is displayed in the same color in each classification of the document. Therefore, even if the documents are stored in the different folders, the documents are displayed in the same color on the document map 42, e.g. by classifying the documents into the same classification as for “patent”.

In the document managing apparatus 1 having the above configuration, it is possible that the display showing the configuration of the folders of the display window displayed on the display device 17 is replaced with the display showing the configuration of the classification. Namely, the classification information is displayed in the display window based on the classification information which is stored in the item of the classification managed by the document managing table 25. Thus, since the documents can be classified based on the classification information, the user can narrow down the search for the documents based on the classification information displayed in the display window. It is also possible to filter the documents by the classification. Then, the user can search the desired document only from the documents of the specified classification, e.g. by rotating the wheel 34 of the mouse 19 to change the display of the documents on the document searching screen 40.

In the embodiment, the function of realizing the invention is previously recorded in the apparatus. However, the invention is not limited to the embodiment. It is also possible that the same function is downloaded from the network to the apparatus, or that the same function is stored in a recording medium and installed in the apparatus. Any recording medium can be used, as long as the program can be stored in the recording medium such as a CD-ROM and read by the apparatus. It is possible that the function obtained by the previous installation and download is realized in association with an operating system (OS) and the like in the apparatus.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A document managing apparatus comprising:
a file managing unit which manages file managing information, a file of data being entered in the file managing information, the data constituting a document which is a managing target;
a document managing unit which manages pieces of document managing information by arranging the pieces of document managing information in a particular order, the document managing information including classification information on at least classification attached to the document in a plurality of documents managed by the file managing unit;
an extracting unit which extracts text data included in the document;
an analyzing unit which analyzes whether a previously set text data string is included in the text data extracted by the extracting unit or not, the previously set text data string including the classification information attached to the document;
a determining unit which determines whether the classification information is included or not based on the result of the analysis of the analyzing unit;
an obtaining unit which obtains the classification information when the determining unit determines that the classification information is included; and
an entering unit which enters the classification information while related to the document, the classification information being obtained by the obtaining unit, when the document obtaining the classification information is entered in the document managing unit.

2. The document managing apparatus according to claim 1, further comprising
a classification information allocating unit which allocates the previously set classification information to the document when the determining unit determines that the classification information is not included,
wherein the entering unit enters the classification information while relating the classification information to the document, the classification information being allocated by the classification information allocating unit.

3. The document managing apparatus according to claim 1, wherein
the document managing unit further manages color information to show position information in a different color in each piece of classification information, the position information being displayed in an area near a searching screen and showing a position of the document displayed in the searching screen among all the documents searched by the searching screen, when the documents managed by the file managing information are displayed in the particular order in the searching screen of a display unit.

4. The document managing apparatus according to claim 3, wherein
the area near the searching screen has a rectangular shape.

5. The document managing apparatus according to claim 3, further comprising:
a classification information determining unit which determines whether the classification information obtained by the obtaining unit is the classification information managed by the document managing unit or not;
a first color allocating unit which allocates the same color information as for the managed classification information to the document obtaining the classification information, when the classification information determining unit determines that the obtained classification information is the classification information managed by the document managing unit; and
a second color allocating unit which allocates the color information to the document obtaining the classification information, the color information being not allocated to the managed classification information, when the classification information determining unit determines that the obtained classification information is not the classification information managed by the document managing unit,
wherein the entering unit makes the entry while also relating the color information allocated by either the first color allocating unit or the second color allocating unit, when the classification information is entered in relation to the document.

6. A document managing program comprising:
a file managing function of managing file managing information, a file of data being entered in the file managing information, the data constituting a document which is a managing target;
a document managing function of managing pieces of document managing information by arranging the pieces of document managing information in a particular order, the document managing information including classification information on at least classification attached to the document in a plurality of documents managed by the file managing function;
an extracting function of extracting text data included in the document;
an analyzing function of analyzing whether a previously set text data string is included in the text data extracted by the extracting function or not, the previously set text data string including the classification information attached to the document;
a determining function of determining whether the classification information is included or not based on the result of the analysis of the analyzing function;
an obtaining function of obtaining the classification information when the determining function determines that the classification information is included; and
an entering function of entering the classification information obtaining the classification information while related to the document, the classification information being obtained by the obtaining function, when the document obtaining the classification information is entered in the document managing information managed by the document managing function.

7. The document managing program according to claim 6, further comprising
a classification information allocating function of allocating the previously set classification information to the document when the determining function determines that the classification information is not included,
wherein the entering function enters the classification information while relating the classification information to the document, the classification information being allocated by the classification information allocating function.

8. The document managing program according to claim 6, wherein
the document managing function further manages color information to show position information in a different color in each piece of classification information, the position information being displayed in an area near a searching screen and showing a position of the document displayed in the searching screen among all the documents searched by the searching screen, when the documents managed by the file managing information are displayed in the particular order in the searching screen of a display unit.

9. The document managing program according to claim 8, wherein
the area near the searching screen has a rectangular shape.

10. The document managing program according to claim 8, further comprising:
a classification information determining function of determining whether the classification information obtained by the obtaining function is the classification information managed by the document managing function or not;
a first color allocating function of allocating the same color information as for the managed classification information to the document obtaining the classification information, when the classification information determining function determines that the obtained classification information is the classification information managed by the document managing function; and
a second color allocating function of allocating the color information to the document obtaining the classification information, the color information being not allocated to the managed classification information, when the classification information determining function determines that the obtained classification information is not the classification information managed by the document managing function,
wherein the entering function makes the entry while also relating the color information allocated by either the first color allocating function or the second color allocating function, when the classification information is entered in relation to the document.

11. A method of entering document classification of a document managing apparatus, the method comprising:
managing file managing information, a file of data being entered in the file managing information, the data constituting a document which is a managing target;
managing pieces of document managing information by arranging the pieces of document managing information in a particular order, the document managing information including classification information on at least classification attached to the document in the plurality of managed documents;
extracting text data included in the document;
analyzing whether a previously set text data string is included in the extracted text data or not, the previously set text data string including the classification information attached to the document;
determining whether the classification information is included or not based on the result of the analysis;
obtaining the classification information when it is determined that the classification information is included; and
entering the obtained classification information while related to the document, when the document obtaining the classification information is entered in the managed document managing information.

12. The method according to claim 11, further comprising
allocating the previously set classification information to the document when it is determined that the classification information is not included,
wherein the entering enters the classification information while relating the classification information to the document.

13. The method according to claim 11, wherein
the managing the document managing information further manages color information to show position information in a different color in each piece of classification information, the position information being displayed in an area near a searching screen and showing a position of the document displayed in the searching screen among all the documents searched by the searching screen, when the documents managed by the file managing information are displayed in the particular order in the searching screen of a display unit.

14. The method according to claim 13, further comprising:
determining whether the obtained classification information is the managed classification information or not;
allocating the same color information as for the managed classification information to the document obtaining the classification information, when it is determined that the obtained classification information is the managed classification information; and
allocating the color information to the document obtaining the classification information, the color information being not allocated to the managed classification information, when it is determined that the obtained classification information is not the managed classification information,
wherein the entering makes the entry while also relating the color information, when the classification information is entered in relation to the document.
